(19) United States
(12) Patent Application Publication
(10) Pub. No.: US 2008/0251080 A1
(43) Pub. Date: Oct. 16, 2008

(54) Second stage regulator

(76) Inventor: George Simmons, Panama, OK (US)

Correspondence Address: HENRY LAW FIRM, P.O. BOX 1105, FAYETTEVILLE, AR, 72702, US

(21) Appl. No.: 11/787,045

(22) Filed: Apr. 13, 2007

(51) Int. Cl. A62B 9/02

(52) U.S. Cl. 128/205.24

(57) ABSTRACT

An improved second stage regulator has a conservation chamber for conserving air exhaled by a diver from anatomic dead space. The conservation chamber is divided into two parts by a flexible diaphragm, which allows the conservation chamber to fill upon a diver's exhalation and recycles this air upon the diver's inhalation.

### CROSS REFERENCES

None.

### GOVERNMENTAL RIGHTS

None.

### BACKGROUND OF THE INVENTION

Since ancient times, humans have recognized a need to prolong the time one can stay underwater in order to gather food, to collect precious seabome objects, or to engage in warfare. The first recorded underwater breathing device was a hollow reed used as a snorkel, which had the disadvantage that the diver had to stay near the surface. Diving bells followed shortly thereafter and used the same concept as hollow reeds, but had the disadvantage that the diver could only travel as far as the diving bell's air tube allowed. Diving bells were the sole form of underwater respiration for centuries, and thus there was long a need for a self-contained underwater breathing apparatus.

In the 1800's, the first self-contained underwater breathing apparatuses (SCUBA) were built. These SCUBA designs generally took two forms: (1) a wet design, in which an air tank provides an air supply to the mouth and/or nose, or (2) a dry design, which utilize pressurized, full-body suits. Today, the former design is generally used in recreational, commercial, sporting, and combat settings, whereas the latter is used almost exclusively for deep and/or cold water diving. The inventor's improved second stage regulator concerns wet design SCUBA devices.

SCUBA designs improved dramatically in the 20th century. Of primary importance was the invention of the automatic demand valve, which releases air from the SCUBA tank when the diver inhales. That is, an automatic demand valve allows a diver to breathe normally while underwater, and the design of the automatic demand valve has remained essentially unchanged over the past sixty years.

The basic components of a SCUBA system include an air tank for holding compressed air, a first-stage regulator attached to the tank for providing air at a constant pressure to one or more automatic demand second-stage regulators, and hoses connecting the first- and second-stage regulators. A typical automatic demand second-stage regulator comprises a closed-circuit demand valve housing, which includes a demand valve connected to the hose from the first-stage regulator and a mouthpiece for delivering air into a diver's lungs upon demand. Under neutral pressure, this demand valve is kept in a closed position by a spring. When a diver inhales, the resulting change in pressure exerts force upon a diaphragm, which actuates a valve opening arm that opens the demand valve. The demand valve remains open until the gas pressure inside the regulator equalizes with the ambient pressure outside the regulator, which typically occurs just as the diver finishes inhaling. At this point, the demand valve closes because the diaphragm returns to a neutral, closed position. When the diver exhales, the air from the diver's lungs exits the second-stage regulator into the water through one or more exhale valves such that substantially all of the exhaled air is expelled into the water. A second stage regulator may have a purge button feature that allows a diver to manually trigger the valve opening arm; however, the purge button is rarely used and is typically reserved for removing water from the interior of a backup second-stage regulator.

In most SCUBA applications, the limiting factor for how long a diver can remain underwater is the amount of air available to the diver. It is thus advantageous to prolong a dive by maximizing the efficiency of a SCUBA device. The current design of the automatic demand second-stage regulator suffers from inefficiencies for two reasons. The first reason is that human lungs absorb only about one-quarter (25%) of the oxygen made available by open-circuit breathing sets. Complicated rebreather apparatuses are known in the art that attempt to recycle the remaining three-quarters of the oxygen; however, such rebreathers typically rely upon chemical reactions to scrub carbon dioxide from and add oxygen to exhaled air. The chemicals used in such designs may cause harm to humans, so rebreathers are typically limited to specific types of military and professional applications.

The second inefficiency relates to the existence of anatomic dead space within the human body. When air is inhaled by a diver, not all of the air drawn from a second stage regulator is inhaled into the lungs; some of the air remains in the mouth and conducting airways above the level of the terminal bronchioles. The air trapped in anatomic dead space is not used in the respiration process; rather, it is exhaled unchanged. In a normal person, the volume of anatomic dead space is approximately 150 ml, whereas the total tidal volume for each breath is about 500 ml. Thus, approximately thirty percent (30%) of air inhaled in a SCUBA system is not used, but is instead wasted. It is thus the primary object of the inventor's improved second stage regulator to recapture as much of the unused air as possible in order to conserve the usable air available in a SCUBA system.

It is yet another object of the inventor's improved second stage regulator to provide an air-conserving apparatus that may be added onto existing automatic demand SCUBA second-stage regulators.

It is a further object of the inventor's improved second stage regulator to recapture air exhaled from anatomic dead space without using harmful chemicals.

### BRIEF SUMMARY OF THE INVENTION

The apparatus in accordance with the inventor's improved second stage regulator provides a second-stage SCUBA regulator that allows a diver to extend dive times by conserving air exhaled from anatomic dead space.

The apparatus comprises a conservation chamber factory-mounted to a demand valve housing or retrofitted to a standard second-stage regulator. One or more tubes connect the regulator mouthpiece and the conservation chamber. The conservation chamber is also connected to the exhaust port of the demand valve housing or standard second-stage regulator. A flexible diaphragm divides the conservation chamber into a first side for conserving air and a second side for allowing exhaled air to exit the entire apparatus via an exhaust vent.

The advantages of this design are revealed by way of an example of the unit's operation. When a diver exhales, the air from the anatomic dead space travels into a first side of the conservation chamber. In response to this increase in air pressure, the diaphragm deflects towards a second side of the conservation chamber until the conservation chamber is substantially filled with the exhaled air. Excess exhaled air from the diver's lungs exits the apparatus through the exhaust vent. When the diver draws the next breath, the air trapped inside the first side of the conservation chamber returns to the mouthpiece and is again inhaled by the diver. Once substantially all air from inside the conservation chamber is re-inhaled, the pressure inside the conservation chamber is such that the continued intake of breath by the diver activates the demand valve and air from the diver's tank enters the demand valve housing substantially according to the prior art.

These and other advantages will become apparent from the following detailed description which, when viewed in light of the accompanying drawings, disclose the embodiments of the inventor's improved second stage regulator.

### BRIEF DESCRIPTION OF THE DRAWINGS

FIG. 1 is a perspective view showing an improved second stage regulator as worn by a diver.

FIG. 2 is a perspective view of an improved second stage regulator.

FIG. 3 is a side view of an improved second stage regulator.

FIG. 4 is a cut-away view of an improved second stage regulator along the line 4-4 of FIG. 2.

FIG. 5 is an exploded view of an improved second stage regulator.

Throughout the drawings, like numbers are used to refer to like features of an improved second stage regulator.

### DETAILED DESCRIPTION OF THE INVENTION

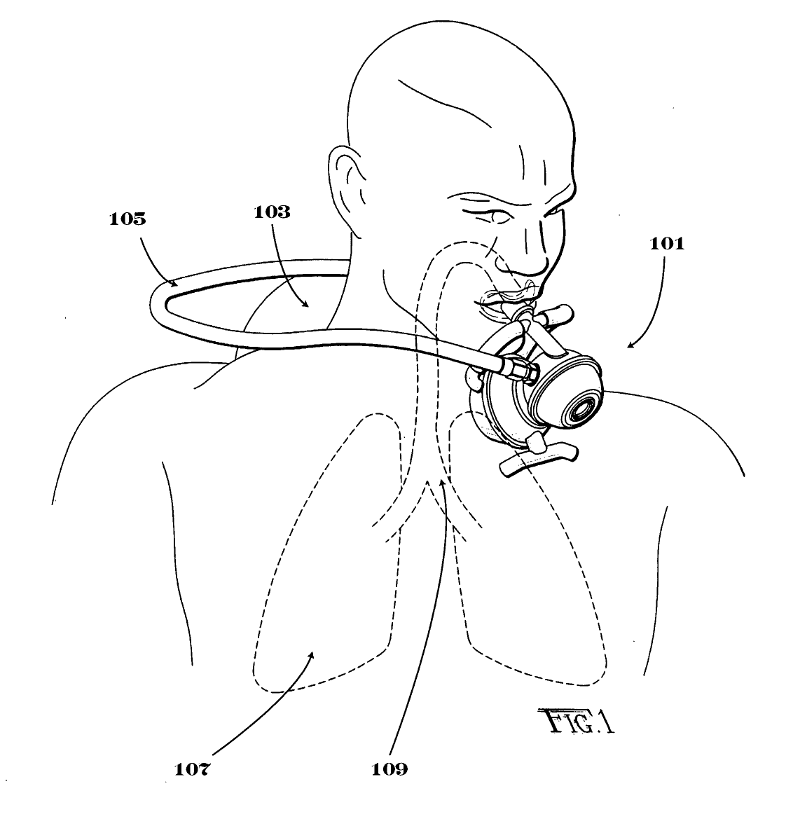

Referring now to FIG. 1, an improved second stage regulator 101 operates much like second stage regulators of the prior art. A diver attaches the improved second stage regulator to a first stage regulator (not shown) attached to an air tank 103 via hose 105. The first stage regulator and improved second stage regulator 101 generally operate to supply air on demand to the diver's lungs 107 at a usable pressure. The inventive step of the improved second stage regulator is that it conserves air exhaled from anatomic dead space 109 during the diver's normal respiratory cycle.

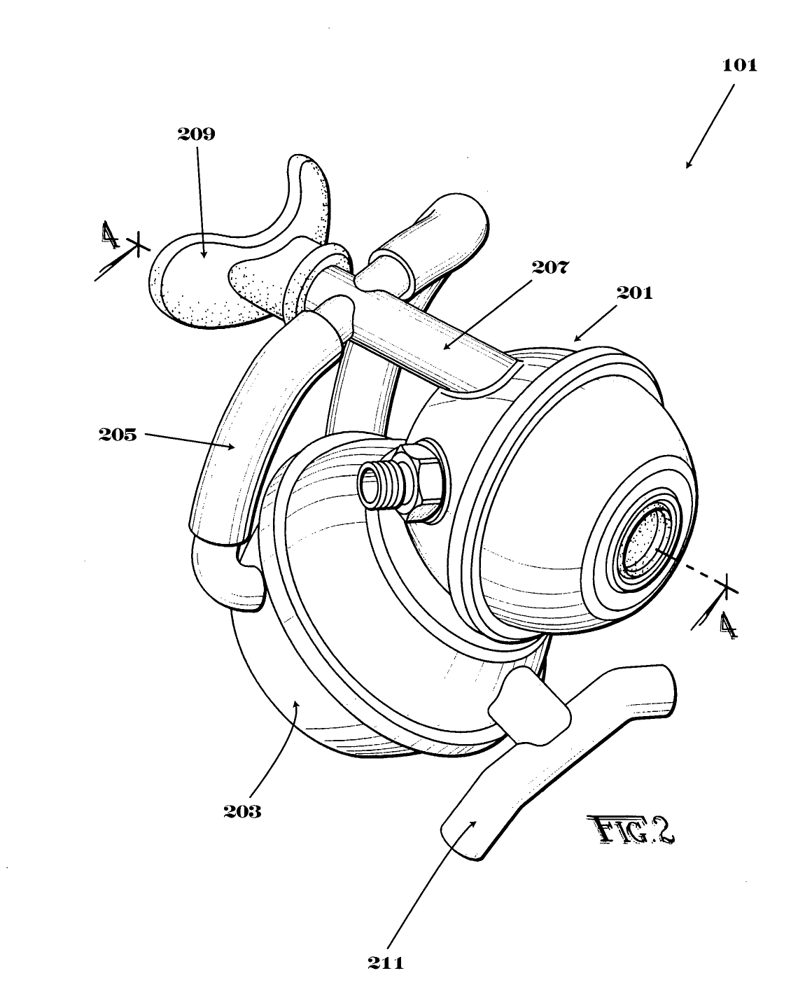

Referring now to FIG. 2, improved second stage regulator 101 comprises several additional components in addition to a demand valve housing 201. Conservation chamber 203 is connected to passageway 207 via one or more tubes 205. Tubes 205 serve as a conduit for air between mouthpiece 209 and conservation chamber 203. Passageway 207 may be elongated and may take many forms. Improved second stage regulator 101 also comprises an exhaust vent 211. When the diver is positioned in most normal diving attitudes relative to the horizontal, exhaust vent 211 serves to retain a volume of air, which aids the operation of improved second stage regulator 101.

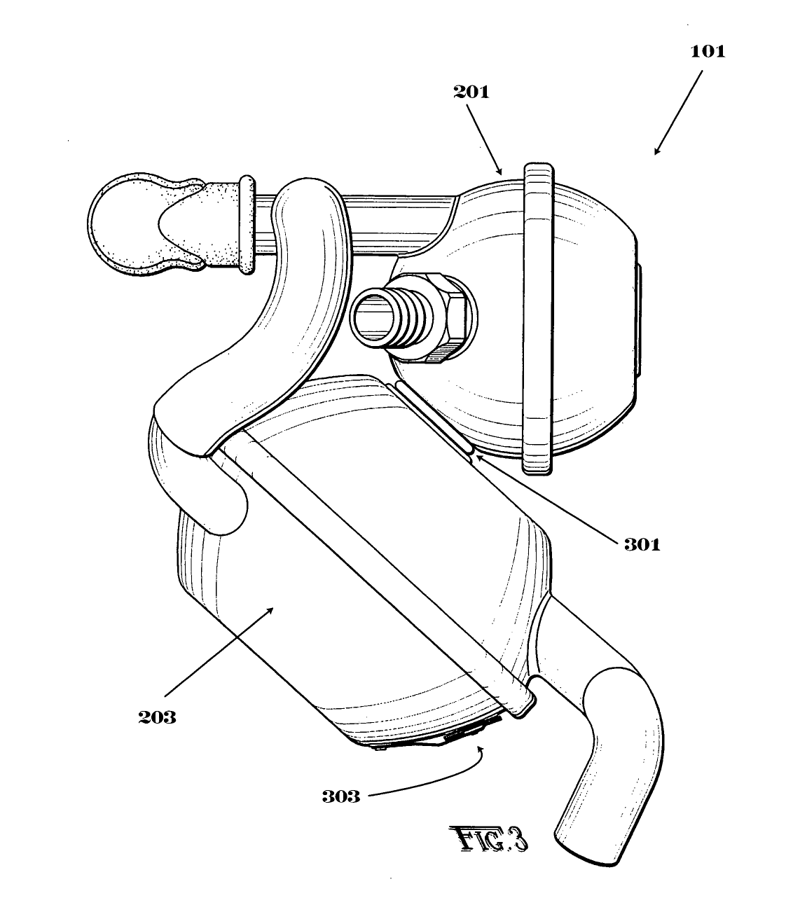

Referring now to FIG. 3, improved second stage regulator 101 is shown in a horizontal attitude. Conservation chamber 203 is mounted to an exhaust port 301 of demand valve housing 201 such that improved second stage regulator 101 can be retrofitted from an existing second stage regulator of the prior art. Conservation chamber 203 has an exhaust valve 303 that allows a diver to clear water from conservation chamber 203 by covering exhaust vents 211 while exhaling.

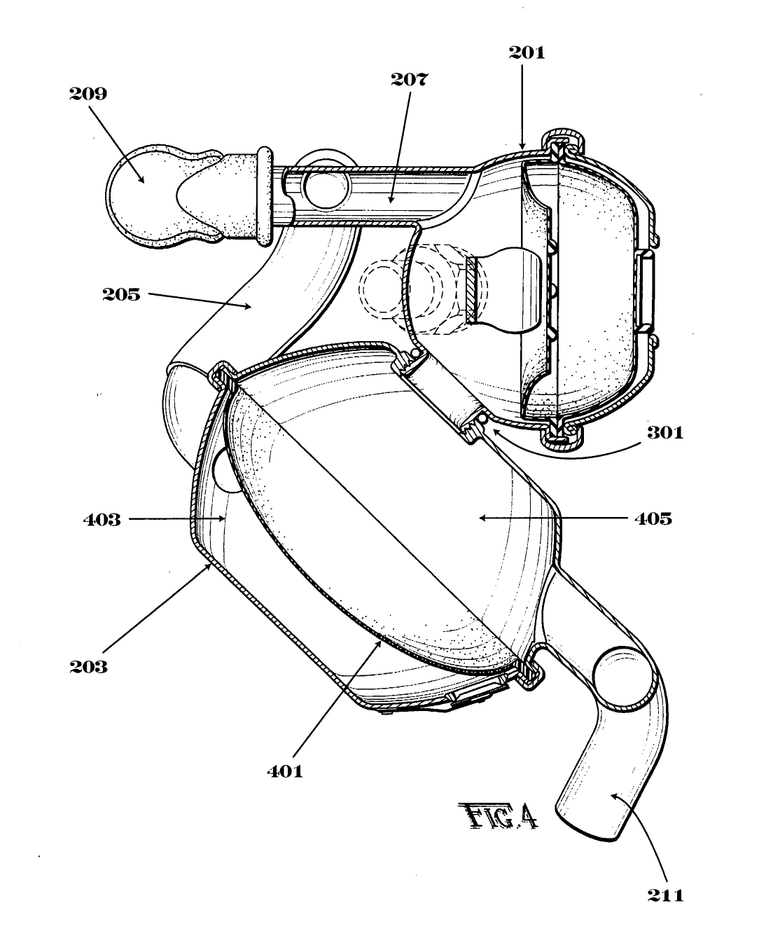

Referring now to FIG. 4, two sides of conservation chamber 203 are defined by a chamber diaphragm 401. First side 403 of conservation chamber 203 is designed to fill with oxygen-rich air from the anatomic dead space when a diver exhales and to return this air when the diver inhales. Second side 405 forms the pathway for aspirated, exhaled air to exit improved second stage regulator 101 along the pathway defined by mouthpiece 209, passageway 207, demand valve housing 201, exhaust port 301, second side 405, and exhaust vent 211.

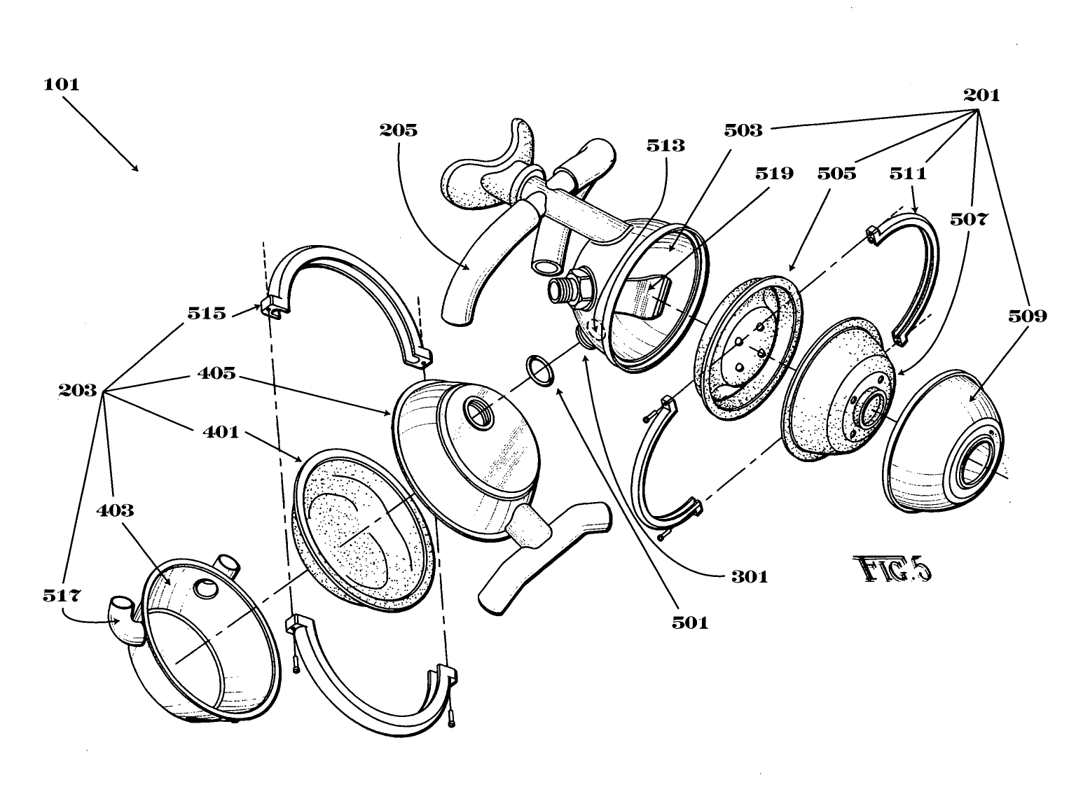

Referring now to FIG. 5, construction of the preferred embodiment of improved second stage regulator 101 begins by attaching second side 405 of conservation chamber 203 to the exhaust port 301 of the demand valve housing 201 in such a manner as to secure a seal 501 between the two components. As shown in FIG. 5, demand valve housing 201 comprises a mouthpiece side 503, a regulator diaphragm 505, a optional manual depressor button 507, a water side 509, and one or more regulator clamps 511. This attachment may be accomplished in retrofit applications by adding a hollow threaded mount to the exterior of mouthpiece side 503 or optionally by means of a shunt threaded on both ends that passes through openings in both second side 405 and mouthpiece side 503. A one-way exhaust port valve 513 is inserted into the opening between demand valve housing 201 and conservation chamber 203 and regulates the flow of air between demand valve housing 201 and conservation chamber 203.

The remaining components of demand valve housing 201 are then assembled, including regulator diaphragm 505, optional manual depressor button 507, and water side 509, which are secured by regulator clamps 511. Some regulators of the prior art will contain somewhat different components; for instance, in some instances, regulator diaphragm 505 and manual depressor button 507 are combined into the same component. The inventor contemplates that improved second stage regulator 101 can be retrofitted from virtually any second stage regulator of the prior art.

Conservation chamber 203 is then assembled by placing chamber diaphragm 401 between first side 403 and second side 405 of conservation chamber 203, and this configuration is secured and sealed using chamber clamps 515. Tubes 205 are then secured to tube fittings 517, which completes the construction of improved second stage regulator 101.

Improved second stage regulator 101 operates by taking advantage of the difference in air pressure required to deflect chamber diaphragm 401 and the air pressure needed to open demand valve 519 and exhaust port valve 513. Throughout the diver's breathing cycle, these pressure differentials allow flexible chamber diaphragm 401 to deflect in such a way as to capture, and then return, air from anatomic dead space using conservation chamber 203 prior to opening either demand valve 519 (during inhalation) or exhaust port valve 513 (during exhalation).

To illustrate the operation of the inventor's improved second stage regulator, as a diver exhales, the exhaled air takes the path of least resistance. Initially, due to the greater resistance offered by the exhaust port valve, the path of least resistance is through tubes 205 and into conservation chamber 203, which causes chamber diaphragm 401 to deflect. When chamber diaphragm 401 deflects to a predetermined pressure, the resistance to air attempting to travel into conservation chamber 203 becomes greater than the resistance to air attempting to travel out of the system through demand valve housing 201, exhaust port 301, second side 405, and exhaust vent 211.

In contrast, as the diver inhales, the air trapped within the first side 403 of conservation chamber 203 returns through tubes 205 to the mouthpiece 209 because of a force acting upon chamber diaphragm 401 due to pressure exerted by formerly-exhaled air trapped on the second side 405 and in chamber exhaust vent 211. Air trapped on second side 405 is pressurized by ambient water, which can travel freely through exhaust vent 211. Thus, the positive pressure exerted by air on second side 405 is higher than the vacuum required to trigger demand valve 519 and air from first side 403 is delivered to the diver's lungs 107. Once chamber diaphragm 401 fully deflects towards the diver, the diver's continued inhalation creates the necessary vacuum required to trigger demand valve 519.

Conservation chamber 203 may range in interior volume to accommodate divers of different sizes. For instance, conservation chamber 203 would need to be comparably larger in an application for a large man, whereas a small woman would need a comparably smaller conservation chamber 203 in order to maximize efficiency of the improved second stage regulator 101. An average size for conservation chamber 203 is 150 ml, which is the volume of anatomic dead space of an average person.

Tubes 205 are large enough in diameter to offer little or no resistance to air attempting to pass through tubes 205 into conservation chamber 203. Passageway 207 may be extended or shortened to accommodate tubes 205.

Optionally, clamps or valves may be added as a safety feature to tubes 205 such that tubes 205 may be closed off by a diver in case of a malfunction of improved second stage regulator 101. When tubes 205 are closed off, exhaled air bypasses conservation chamber 205, and improved second stage regulator 101 operates in the manner of a standard second stage regulator of the prior art. Such features may require flexible tubes 205.

In accordance with the present disclosure, an improved second stage regulator provides longer tank life for divers by recycling air exhaled from anatomic dead space. However, it should be clear that the improved second stage regulator disclosed herein is not to be construed as limited to the forms shown, which are to be considered illustrative rather than restrictive. For example, tubes 205 comprise passageways for air travel between conservation chamber 203 and mouthpiece 209, and tubes 205 may take the form of an interior portion of a cast, injection-molded, or otherwise fixed structure rather than an exterior or removable feature. The inventor also contemplates that chamber diaphragm 401 may be replaced or augmented by other structures or materials capable of reacting to or being displaced by slight changes in air pressure, including but not limited to a baffle, balloon, piston, and/or bellows. Furthermore, the improved second stage regulator may be built as a tightly integrated, stand-alone unit rather than as a retrofit to existing second stage regulators of the prior art.

I claim:

1. An improved second stage regulator apparatus, comprising a conservation chamber for capturing and recycling air exhaled from a diver's anatomic dead space.

2. The apparatus of claim 1, wherein the conservation chamber further comprises a chamber diaphragm that defines a first side and a second side of the conservation chamber.

3. The apparatus of claim 1, wherein the conservation chamber further comprises:
a chamber diaphragm that defines a first side and a second side of the conservation chamber, and
an exhaust valve for clearing water from the first side.

4. The apparatus of claim 1, wherein the conservation chamber further comprises:
a chamber diaphragm that defines a first side and a second side of the conservation chamber, and
an exhaust vent for regulating the pressure differential between the first side and second side.

5. The apparatus of claim 1, wherein the apparatus further comprises:
a chamber diaphragm that defines a first side and a second side of the conservation chamber,
an passageway for air between a mouthpiece and a demand valve housing, and
one or more tubes connecting the conservation chamber and the passageway.

6. The apparatus of claim 1, wherein the apparatus further comprises:
a chamber diaphragm that defines a first side and a second side of the conservation chamber,
an exhaust valve for clearing water from the first side,
an exhaust vent for regulating the pressure differential between the first side and second side,
a passageway for air between a mouthpiece and a demand valve housing, and
one or more tubes connecting the conservation chamber and the passageway.

7. An improved second stage regulator apparatus, comprising:
a mouthpiece;
a demand valve housing, further comprising an exhaust port;
a passageway between the mouthpiece and the demand valve housing;
a conservation chamber, further comprising a first side and a second side, a chamber diaphragm, and an exhaust vent;
one or more tubes connecting the conservation chamber to the passageway; and
a seal between the exhaust port of the demand valve housing and the second side of the conservation chamber.
